(19) United States
(12) Patent Application Publication
(10) Pub. No.: US 2017/0156359 A1
(43) Pub. Date: Jun. 8, 2017

(54) NOVEL MILK BEVERAGE COMPOSITION COMPRISING CREATINE

(71) Applicant: Glaxo Group Limited, Brentford, Middlesex (GB)

(72) Inventor: Christopher Neil HARRISON, Brentford, Middlesex (GB)

(21) Appl. No.: 15/038,749

(22) PCT Filed: Nov. 25, 2014
(86) PCT No.: PCT/EP2014/075467

§ 371 Date: May 24, 2016

(30) Foreign Application Priority Data
Nov. 27, 2013 (GB) 1320906.9
Feb. 25, 2014 (GB) 1403271.8

(51) Int. Cl. A23C 9/152; A23C 9/154

(52) U.S. Cl. CPC A23C 9/1526; A23C 9/1544

(57) ABSTRACT

Ready to drink milk beverage compositions are described comprising creatine and an added protein such as whey protein, which have good creatine shelf life at ambient temperatures.

### FIELD OF THE INVENTION

The present invention relates to a ready to drink (RTD) milk beverage composition comprising creatine and an added protein, the composition having good long term storage stability of the creatine at ambient temperatures.

### BACKGROUND OF THE INVENTION

Creatine is a well known nutritional supplement for use by athletes, body builders and sports people to build muscle mass and to enhance athletic performance.

Creatine is often taken in a powder or tablet format that is mixed with a drink such as water, a fruit juice, milk or a hot beverage such as coffee or tea, just prior to consumption. The reason for this is that creatine, in an acidic or neutral aqueous solution, is converted over time into an inactive compound, creatinine. This conversion is known to be accelerated at ambient or elevated temperatures.

Therefore, creatine generally needs to be stored in a dry format prior to use or, in the case of a RTD beverage, the composition should be stored at low temperature to maintain adequate storage stability of the creatine, for example as described in GB-A-2313544.

Alternatively, since creatine is stable in an alkaline aqueous environment, RTD beverages comprising creatine have been described in EP-A-669083, wherein the compositions have been rendered weakly alkaline to maintain good storage stability of the creatine.

A US marketed RTD beverage, promoted as containing a mixture of whey and casein proteins and a patented form of creatine (Kre-Alkalyn®), is Cytosport's Monster Milk product. Although named “Monster Milk”, this product is not a milk beverage and indeed is stated to contain no milk. However, it is stated to contain ingredients derived from milk including a milk protein isolate. This product utilises the technology described in U.S. Pat. No. 6,399,661 in which creatine is pre-mixed with an alkaline powder to stabilise the creatine which can then mixed with water. A 591 ml bottle of this product was found to contain only 0.06 g of creatine (which is about 0.01% by weight of the composition).

RTD beverages containing water-stable derivatives of creatine are also known, such as the BANG® energy drinks marketed in the US by VPX Sports Nutrition. These drinks either contain creatinol-O-phosphate (as described in U.S. Pat. No. 8,372,821) or amide derivatives of creatine (as described in U.S. Pat. No. 8,445,466). A 473 ml can of a BANG® RTD beverage was found to contain a negligible amount of free creatine (ca 0.001% by weight of the composition). These BANG® RTD beverages are not milk beverages.

Uzzan et al, Journal of Food Science, 72 (3), 2007, E109 to E114 describes the thermal and storage stability of various nutraceuticals (including creatine) in a milk beverage dietary supplement. This paper suggests that whilst creatine in a milk beverage is satisfactorily stable during typical thermal sterilization treatments for such beverages (such as pasteurization, boiling or UHT), creatine degrades rapidly on storage, having a shelf life of only 2 months at room temperature which can, however, be extended to at least 3 months under refrigeration.

It has now been discovered that when a protein is added to a milk beverage composition comprising creatine, the long term storage stability of the creatine is surprisingly improved, the composition having a commercially acceptable shelf life of at least 9 months, at ambient temperature.

### SUMMARY OF THE INVENTION

Accordingly, in a first aspect, the present invention provides a RTD milk beverage composition comprising creatine and a stabilising amount of an added protein or a protein hydro lysate.

### BRIEF DESCRIPTION OF THE DRAWINGS

FIG. 1 is a graph showing levels of creatinine (the degradation product of creatine) over a 5 week period when creatine is incorporated into two milk beverages, one with added whey protein (MaxiMilk) and one with no added whey protein (Milk Base).

### DETAILED DESCRIPTION OF THE INVENTION

Suitable forms of creatine for incorporation into the composition of the present invention include the monohydrate or an orally acceptable salt of creatine.

Preferably the creatine is the monohydrate.

Suitably the composition comprises from 0.1 to 10%, more suitably from 0.5 to 5%, most suitably from 1 to 2%, of creatine by weight of the composition.

These amounts of creatine relate to the initial amount of creatine added to the composition, which amount will fall over time due to some degradation of the creatine to creatinine during storage. Therefore, in order to ensure that the desired dose of creatine is available when the product is consumed, these initial amounts of creatine include an appropriate excess to take into account any degradation of creatine that occurs upon long term storage.

The added protein or protein hydrolysate may be of animal or vegetable origin or a mixture thereof.

Examples of proteins of animal origin include whey protein, casein, keratin, collagen, elastin, fibroin or albumin or a mixture of thereof.

Examples of proteins of vegetable origin include rice protein, soya protein, wheat or wheat germ protein, oat protein, potato protein, pea protein or a nut protein such as almond protein, or a mixture thereof.

A protein hydrolysate is a degradation product obtained by the acidic, alkaline and/or enzymatic hydrolysis of an animal or vegetable protein.

The preferred added protein is whey protein or a hydrolysate thereof.

The added protein or protein hydrolysate should be present in an amount to stabilise creatine against significant degradation to creatinine in a milk beverage composition at ambient temperature (of 21° C.) for at least 9 months. The degradation from creatine to creatinine should suitably be less than 50%, more suitably less than 45%, and preferably less than 40% over 9 months at a temperature of 21° C.

Suitably the composition of the present invention comprises from 1 to 25%, more suitably from 2 to 15%, most suitably from 5 to 10% of added protein or protein hydrolysate by weight of the composition.

The composition of the present invention may further comprise one or more agents conventionally used in nutritional supplement or beverage compositions, including a carbohydrate such as a sugar, an essential or non-essential amino acid, a lipid, a mineral salt, a vitamin, a trace element, an electrolyte, an anti-oxidant, a sweetener, a flavouring agent, a stabiliser, a preservative, a colouring agent, or a buffer.

Suitably the composition of the present invention comprises an amino acid, which can be a non-essential amino acid, such as glutamine or which can be an essential amino acid, eg a branched chain amino acid such as leucine, isoleucine or valine.

Suitably the composition of the present invention comprises a stabiliser selected from a complex polysaccharide gum or other natural or synthetic polymer having viscosity modulating properties that are routinely added to beverages. These polymers include natural and semi-synthetic polymer materials such as carrageenan, alginates, locust bean gum, gellan gum, guar gum, gum arabic, xanthan gum, pectin, cellulose, and derivatives thereof; synthetic polymers such as polyvinylpyrrolidone (PVP) and other such materials known in the art. Preferably the stabiliser is carrageenan.

Suitably the stabiliser is present in an amount from 0.01 to 1%, for example from 0.05 to 0.5%, by weight of the composition.

Whilst the composition of the present invention may comprise a buffer, there is actually no need to include an added buffer, because of the natural buffering properties of milk. Therefore, suitably the composition of the present invention does not contain an added buffer.

Contrary to the teaching of U.S. Pat. No. 6,399,661, there is no need to include an alkaline agent, unlike the above-noted Cytosport product containing Kre-Alkalyn®. Therefore, suitably the composition of the present invention does not contain a pre-mix of creatine with an alkaline powder, eg as described in U.S. Pat. No. 6,399,661.

Suitably the pH of the composition of the present invention is that of natural milk and is typically within the range of 6.5 to 7.0, eg from 6.6 to 6.8, and is stable over time.

The balance of the composition of the present invention is made up with liquid milk, eg from 75 to 95% by weight of the composition is milk, depending upon the quantities of the other ingredients included in the composition.

Suitably the milk may be skimmed, semi-skimmed or full fat milk and may be cows, sheep, goats or soya milk.

Suitably the milk is cows milk.

Suitably the milk is skimmed milk.

The milk may be from fresh milk or may be prepared by mixing powdered milk with water. However obtained, the milk needs to be sterilised to provide long term storage stability of a RTD milk beverage. Therefore, the composition of the present invention is sterilised.

Methods of sterilizing milk beverages are well known in the beverage art and include pasteurization, boiling for short periods, or UHT (ultra high temperature) processing. The composition of the present invention may also be sterilised by passing through a bacterial filter to remove any unwanted bacteria.

The composition of the present invention may be prepared by mixing the ingredients according to conventional methods. The solid ingredients may be dissolved or suspended in liquid milk (or water if using powdered milk), and the resulting product typically sterilised prior to filling into bottles or cans or may be “in-pack sterilised” after filling.

The invention is further illustrated by the following Examples.

### Example 1—Ready to Drink Beverage—Creatine/Whey Protein

A ready to drink beverage was prepared by mixing the following ingredients:

| Ingredient | % by weight of the composition |
|---|---|
| Whey Protein | 7.183 |
| Creatine monohydrate | 1.429 |
| Glutamine | 0.228 |
| Natural flavourings | 0.205 |
| Carrageenan | 0.100 |
| Colouring | 0.020 |
| Sweetener (Sucralose) | 0.011 |
| Skimmed Milk (liquid) | 90.824 |

After mixing, the beverage composition was UHT sterilised and then filled into 330 ml bottles providing about 3 g of creatine per serving, upon long term storage.

### Example 2—Preliminary Stability Study

A comparative study was undertaken in order to look at the degradation of creatine in a simple skimmed milk base (containing only skimmed milk and creatine) and in a skimmed milk base (MaxiMilk) containing multiple ingredients including whey protein.

| | Milk Base + Creatine | MaxiMilk + Creatine |
|---|---|---|
| Raw Material | % w/w | |
| Skimmed Milk | 98.488 | 90.09 |
| Creatine Monohydrate | 1.512 | 1.512 |
| Whey Protein | 0.000 | 7.200 |
| Sucralose | 0.000 | 0.100 |
| Aroma | 0.000 | 1.000 |
| carageenan | 0.000 | 0.100 |

Products were made in the laboratory by simply mixing creatine into the respective bases. In this preliminary study over a short five week period the products were not pasteurised.

The samples were monitored for creatinine development over a period of five weeks. Creatinine is a good indicator of creatine stability. It is the only degradent compound of creatine and is easily analysed by HPLC.

TABLE 1
Creatinine formation over a 5 week period

Creatinine g/100 g

| Time (weeks) | MaxiMilk + Creatine | Milk Base + Creatine |
|---|---|---|
| 0 | 0 | 0 |
| 1 | 0.00318 | 0.00112 |
| 2 | 0.00475 | 0.00364 |
| 3 | 0.00612 | 0.00836 |
| 4 | 0.00779 | 0.0165 |
| 5 | 0.00763 | 0.0222 |

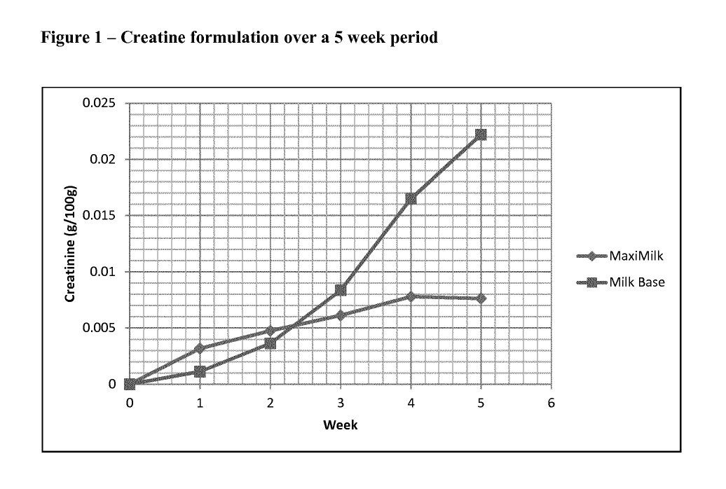

The results shown in FIG. 1 and Table 1 indicate that over a five week period the milk beverage composition comprising creatine with added whey protein (MaxiMilk with creatine) had better creatine stability (as measured by the levels of the degradation product, creatinine) than a milk beverage composition comprising creatine without any added whey protein (Milk Base with creatine).

### Example 3—Long Term Storage Stability

The creatine content of the RTD beverage of Example 1 was assessed, using HPLC, over a period of 35 weeks at three different temperatures as summarized in Tables 2 and 3 below.

TABLE 2
levels of creatine per 100 ml

| Creatine Content | | | |
|---|---|---|---|
| after T weeks of | 21° C. | 30° C. | 40° C. |
| storage | g/100 ml | g/100 ml | g/100 ml |
| T0 | 1.500 | 1.500 | 1.500 |
| T4 | 1.045 | 0.920 | 0.790 |
| T9 | 1.130 | 0.930 | 0.700 |
| T13 | 0.995 | 0.865 | 0.765 |
| T17 | 0.960 | 0.770 | 0.670 |
| T21 | 0.905 | 0.765 | 0.730 |
| T26 | 0.930 | 0.810 | 0.720 |
| T31 | 0.880 | 0.800 | No result |
| T35 | 0.890 | 0.850 | No result |

TABLE 3
levels of creatine per 330 ml serving

| Creatine Content after | 21° C. | 30° C. | 40° C. |
|---|---|---|---|
| T weeks of storage | g/serving | g/serving | g/serving |
| T0 | 5.217 | 5.217 | 5.217 |
| T4 | 3.635 | 3.200 | 2.748 |
| T9 | 3.930 | 3.235 | 2.435 |
| T13 | 3.461 | 3.009 | 2.661 |
| T17 | 3.339 | 2.678 | 2.330 |
| T21 | 3.148 | 2.661 | 2.539 |
| T26 | 3.235 | 2.817 | 2.504 |
| T31 | 3.061 | 2.783 | No result |
| T35 | 3.096 | 2.956 | No result |

Referring to Table 2, after an initial drop in creatine levels, between T=0 weeks and T=4 weeks, of about 30% at 21° C. and of about 40% at 30° C., thought to be primarily due to the high temperatures used in the initial sterilization process, the levels of creatine thereafter fell very gradually at temperatures of 21° C. and 30° C.

After T=35 weeks it is evident that the levels of creatine at 21° C. and 30° C. were respectively 0.890 and 0.850 g/100 ml, representing about 60% and 56% of their initial values at T=0 weeks

This low level of degradation is indicative of good storage stability for at least 9 months and probably longer.

Table 3 shows the same data for a 330 ml serving demonstrating that an initial dose of about 5 g per serving at T=0 weeks can deliver a dose of about 3 g per serving after storage for 35 weeks at 21° C. or at 30° C.

This is a surprising finding given the results described in the above-noted Uzzan et al paper indicating that creatine in a milk beverage without any added protein only has a 2 month shelf life at ambient temperature.

1. A stable ready to drink milk beverage composition comprising creatine and an added protein or a protein hydrolysate.

2. A composition according to claim 1 wherein the creatine is present in an amount of 0.1 to 10% by weight of the composition.

3. A composition according to claim 1 wherein the added protein is whey protein or a hydrolysate thereof.

4. A composition according to claim 1 wherein the added protein or a hydrolysate thereof is present in an amount of 1 to 25% by weight of the composition.

5. A composition according to claim 1 further comprising one or more agents conventionally used in nutritional supplement or beverage compositions.

6. A composition according to claim 5 comprising an amino acid.

7. A composition according to claim 5 comprising a stabiliser.

8. A composition according to claim 7 wherein the stabiliser is carrageenan.

9. A composition according to claim 1 which does not contain an added buffer.

10. A composition according to claim 1 which does not contain a premix of creatine with an alkaline powder.

11. A composition of claim 1 wherein the creatine is creatine monohydrate.

12. The composition of claim 1 wherein the creatine degrades to creatinine less than 50% over 9 months at a temperature of 21° C.

13. The composition of claim 1 having a pH within a range of 6.5 to 7.0.
